(19) United States
(12) Patent Application Publication
(10) Pub. No.: US 2011/0215539 A1
(43) Pub. Date: Sep. 8, 2011

(54) POWER TOOL AND CHUCK RELEASE TOOL

(75) Inventors: Benjamin Luke Van Der Linde, Victoria (AU); Paul Francis Connor, Victoria (AU); David Leigh Scrimshaw, Victoria (AU); Paul Davies, Victoria (AU); Paul Miller, Victoria (AU)

(73) Assignee: Demain Technolgy Pty Ltd., Braeside , (AU)

(21) Appl. No.: 12/305,777

(22) PCT Filed: Jun. 19, 2007
(86) PCT No.: PCT/AU2007/000851

§ 371 Date: May 25, 2011

(30) Foreign Application Priority Data
Jun. 19, 2006 (AU) 2006903263

(51) Int. Cl. B23B 31/06

(52) U.S. Cl. 279/147

(57) ABSTRACT

A power tool and a chuck release tool for a power tool, the power tool including a chuck body and a locking means for locking an operational tool within the chuck, the power tool being operable in an adjustment mode to move the locking means between an open position in which the operational tool is free within the chuck and a locking position in which the locking means secures the operational tool within the chuck, and the power tool being operable in a working mode to drive rotation of the operational tool to perform work, the chuck body including a section for direct engagement with a chuck release tool to allow a user to manually move the chuck body and thereby move the locking means between the locking position and the open position, the chuck release tool having an engagement section which directly engages a section of the chuck body to allow a user to manually move the chuck body and thereby move the locking means between the locking position and the open position.

### FIELD OF THE INVENTION

The present invention generally relates to power tools of the type including a chuck and to a chuck release tool. The invention is applicable to hand held power tools, such as power drills and it will be convenient to hereinafter disclose the invention in relation to that exemplary application. However, it is to be appreciated that the invention is not limited to that application but can apply to any tool which includes a chuck for releasably securing an operating tool.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

In its most basic form, a power drill consists of an electric, hydraulic or air powered motor which rotates a chuck device in which a drill bit can be releasably mounted. The chuck device allows various sized drills bits to be interchangeably used with the power drill. Most chucks used in current power drill designs are of a “keyless chuck” configuration in which actuating the locking mechanism of the chuck to secure the drill piece within the chuck is carried out by gripping a body portion of the chuck by hand and rotating the body portion by hand. Alternatively, the locking mechanism of the chuck can be actuated by gripping the body portion of the chuck and maintaining it stationary while operating the motor of the power tool. Accordingly, the operation of this type of mechanism can involve the motor of the power drill rotating a chuck body in the chuck device which in turn moves one or more locking jaws housed within a stationary locking nut or sleeve into engagement with an end of a drill bit inserted in the chuck. The drill bit can be released from the chuck by rotating the chuck body by hand or by operating the drill motor while holding the chuck body stationary and thereby disengaging the locking bolts from the drill bit.

Another form of power drill has an adjustment mode in which the motor of the drill is operable to actuate the locking mechanism of the chuck to secure the drill bit within the chuck without requiring a user to hold or rotate the chuck body by hand. Such a drill also has a working mode in which the motor is operable to drive rotation of the chuck in a manner such that the chuck together with the drill bit can be driven to perform a drilling operation. Such power tools can have a shield or nose cone extending from the drill body and over the chuck.

While the above chuck arrangements provides a quick and easy mounting method for a drill bit, it can be problematic to remove a drill bit from such a drill when the power supply (electricity, compressed air or the like) fails, disabling the motor of the drill. In power drills having an adjustment mode and a working mode or a shield or nose cone extending over the chuck, the problem of removing the drill bit when the power supply fails is more problematic as these drills tend to provide very limited access to the chuck.

It would therefore be desirable to provide a device which assists a user in removing a drill bit or other similar operating tool from a chuck device when the motor of a power tool such as for example a power drill is disabled.

### SUMMARY OF THE INVENTION

According to one aspect of the present invention, there is provided a chuck release tool for a power tool,

the power tool including a chuck having a chuck body and a locking means for locking an operational tool within the chuck, the power tool being operable in an adjustment mode to move the locking means between an open position in which the operational tool is free within the chuck and a locking position in which the locking means secures the operational tool within the chuck, and the power tool being operable in a working mode to drive rotation of the operational tool to perform work,

the chuck release tool having an engagement section which directly engages a section of the chuck body to allow a user to manually move the chuck body and thereby move the locking means between the locking position and the open position.

The present invention is useful for removing an operational tool from a power tool having a chuck that usually does not require a user to manually hold or rotate the chuck body by hand to remove the operational tool by providing a chuck release tool for directly engaging and moving the chuck body to cause it to release the operational tool. Consequently, if a power tool such as an electric drill loses power, say for example the battery goes flat, then the chuck release tool can be used to rotate the chuck body of the chuck and remove any operational tool, such as a drill bit, screw driver bit, hole saw or the like, from the chuck without having to operate the motor of the power tool.

As can be appreciated, the connection between the engagement section of the chuck release tool and the chuck body can have a variety of different configurations. In its most basic form, this connection could comprise a tool end or shaft which interconnects with a correspondingly configured portion of the chuck body, thereby allowing an operator to manually move the chuck body.

In one preferred embodiment, the engagement section of the chuck release tool and the chuck body respectively include at least one rib or slot, the rib interconnecting with a corresponding slot when the engagement section is brought into contact with the chuck body. The rib or slot could be included on either of the engagement section of the chuck release tool or the chuck body. However, it is preferable that the engagement section of the chuck release tool includes two or more laterally extending projections and the chuck body includes corresponding recesses into which the projections can be inserted.

The ribs and corresponding or interconnecting recesses could be of any configuration. Suitable configurations include cylindrical projections, rectangular projections, oval projections, tapered ribs, arcuate ribs, square nodules or the like. It is preferable however that the corresponding recesses or cavities are of substantially the same cross-sectional shape and dimensions and therefore allow the projections to substantially friction fit within the space formed by the cavity. More preferably, the projections are of an elongate cylindrical configuration which substantially friction fit within a cylindrical recess or hole.

In an alternative embodiment, the engagement section of the chuck release tool comprises a shaped recess, slot or hole which is engageable with a correspondingly shaped surface or body included in or on the chuck body. The shaped recess, slot or hole can comprise any suitable configuration which can engage a correspondingly shaped feature of the chuck body and allow the chuck release tool to move the chuck body, the chuck body thereby moving the connected locking means. Suitable configurations include open ended spanner head, ring spanner head, box spanner head, socket type head, alien key type end, wrench head or any other type of fixed jaw or claw type tool type. In a preferred embodiment of the invention, the engagement section of the chuck release tool includes a spanner type head which engages a substantially nut like portion located on the chuck body.

As can be appreciated, the chuck release tool of the present invention can lock or secure into a power tool a large variety of different types of operational tools. For example, in the case of a power drill, the chuck is designed to accommodate drill bits, screw driver tool bits, socket bits, saw bits, alien key adaptor bits, stirrer sticks, buffing adaption tool bits or the like.

Ideally, the chuck release too designed to fit into and around any operational tool inserted into the chuck. In this respect, it is preferable for the chuck release tool of the present invention to have an engagement section which includes an aperture or recessed portion for accommodating, housing, seating or otherwise receiving a portion of the operational tool. In a preferred embodiment of the invention, the aperture or recessed portion comprises a recess which is shaped to axially receive a generally cylindrically shaped operational tool. For example, in the case of a power drill, the aperture or recessed portion has a configuration which receives the shank of a drill bit. In this example, either a circular hole or a recess would be suitable.

As previously discussed, a chuck body of a chuck is designed to engage or disengage one or more locking means with an end of an operational tool such as a drill bit inserted in the chuck. In a preferable embodiment of the invention, the chuck release tool rotates the chuck body to move the locking means between an open position and a locking position. However, it is to be understood that various other possible movements such as pushing, pulling, slotting, sliding or the like which could disengage the locking means from the operational tool. It is preferable, that the locking means includes a one or more jaws which are moved into engagement with the operational tool in the locking position. Preferably, the locking jaws are housed within a portion of the chuck body including a locking sleeve or nut. More preferably, the locking jaws have a threaded engagement within the locking sleeve or nut.

The chuck release tool preferably includes a handle to facilitate manual manipulation of the tool in a users hand. In one embodiment, the handle includes a cylindrical hand engagement section. The hand engagement section can optionally include finger recesses or grip portions, thumb engagement or rest portion, flutes, stripes or any other desirable functional and/or decorative means. However, in such embodiments, it is preferable for the chuck release tool to include a rectangular section attached to an end of the hand section, the rectangular section including two or more laterally projecting ribs which have a generally perpendicular orientation to an axis along the longitudinal length of the handle.

In some embodiments of the invention, the chuck release tool according to the present invention includes an attachment device which allows the chuck release tool to be releasably secured to the power tool. Such an attachment device ensures that the chuck release tool can be readily housed on or with the power tool and therefore easily found when an operator needs to use the tool. It is preferable that the attachment device includes a handle.

The attachment device can take many forms. In one embodiment, the attachment device includes a recessed section located in the body or handle of the power tool design to house the chuck release tool. In another embodiment, the attachment device includes a strap which can be attached to a hook or other fastening device affixed to the power tool. In a preferred embodiment of the invention, the attachment device includes a circumferentially adjustable ring.

It is advantageous for any component of a power tool to be attached, integrated or otherwise incorporated into a component or functional section of the power tool. For example, in some embodiments of the invention, the chuck release tool is integrally formed into or with the electrical cord, plug, power tool case, removable battery section, or other attachable or removable section of the power tool. In a preferred embodiment of the invention, the chuck release tool is integrated into an auxiliary or side handle which can be releasably attached to the power tool. In the case of a power drill, the auxiliary or side handle can be attached proximate to the chuck portion of the drill.

In many types of power tools, the chuck is housed within a recessed or covered portion. Accordingly, in one embodiment of the present invention, the chuck body of the power tool is housed in a recessed section. In this embodiment, the engagement section of the chuck release tool extends from an elongate section which can be inserted within the recessed section, thereby enabling the engagement section to engage the cooperating portion of the chuck body. In an alternative embodiment of the invention, the power tool includes a releasably securable front fascia/cover which can be removed to expose the chuck body and thereby allow the engagement section of the chuck release tool to engage the cooperating portion of the chuck body.

It may be desirable in some forms of the present invention to only enable manual movement of the chuck when the power tool is switched into a particular mode. This could be used as a safety mode, ensuring that the motor or the power tool is not engaged or powered. Furthermore, this mode could also isolate certain sections such as gearing of the power tool which may be damaged when the chuck is moved by a force other than the motor. The chuck body therefore could only be manually moved by the chuck release tool when the power tool is placed in this safety mode.

According to another aspect of the invention, there is provided a power tool including a chuck having a chuck body and a locking means for locking an operational tool within the chuck, the power tool being operable in an adjustment mode to move the locking means between an open position in which the operational tool is free within the chuck and a locking position in which the locking means secures the operational tool within the chuck, and the power tool being operable in a working mode to drive rotation of the operational tool to perform work, the chuck body including a section for direct engagement with a chuck release tool to allow a user to manually move the chuck body and thereby move the locking means between the locking position and the open position.

In one form, the power tool is switchable between the adjustment mode and the working mode. The power tool may also include a motor that is operable in the adjustment mode to move the locking means between the open position and the locking position, and that is operable in the working mode to drive rotation of the operational tool to perform work.

As can be appreciated, the chuck body can have a variety of different configurations. In one form, the chuck body includes at least one rib or slot for interconnecting with a rib or slot of the chuck release tool. In another form, the chuck body includes recesses in which projections of the chuck release tool can be inserted. The recesses may be in a front surface of the chuck body. In yet another form, the chuck body includes a shaped recess, slot or hole which is engageable with a correspondingly shaped surface or body included in or on the chuck release tool. The chuck body may include a nut like portion for engagement with a spanner type head of the chuck release tool.

In one form, the chuck body of the power tool is housed in a recessed section into which can be inserted the chuck release tool for enabling the direct engagement of the chuck body and the chuck release tool.

### BRIEF DESCRIPTION OF THE DRAWINGS

The present invention will now be described with reference to the figures of the accompanying drawings, which illustrate particular preferred embodiments of the present invention, wherein:

FIG. 1 is a perspective view of a hand held tool incorporating one particular embodiment of the chuck release tool of the present invention.

FIG. 2 is a perspective view of a releasably attachable side handle for a drill which incorporates another embodiment of the chuck release tool of the present invention.

FIG. 3 is a cross-sectional view of one half of one form of a chuck in a closed position. The chuck can be used with a chuck release tool shown in FIG. 1 or 2.

FIG. 4 is a cross-sectional view of one form of a chuck shown in FIG. 3 in an open position.

FIG. 5 is a front end elevation view of the drill and chuck release tool of shown in FIG. 1 in position for use to operate a chuck of a battery operated hand drill.

FIG. 6 is a cross-sectional view of the drill and the chuck release tool viewed along line A-A of FIG. 5.

FIG. 7 is a side elevation view of the chuck release tool and drill shown in FIG. 5 in which the engagement pins have been inserted into the chuck.

FIG. 8 is a side elevation view of the chuck release tool and drill shown in FIG. 7 in which the chuck release tool has been rotated and the drill piece has been removed from the chuck.

FIG. 9 is a side elevation view of a battery operated hand drill incorporating chuck having a removable front fascia/cover which cooperates with another embodiment of the chuck release tool of the present invention.

FIG. 10 is a side elevation view of the drill shown in FIG. 9 with the front fascia removed exposing a chuck nut on which the chuck release tool engages.

FIG. 11 is a side elevation view of the drill shown in FIG. 10 with the front fascia removed and exposing chuck release tool engaged with the chuck nut.

FIG. 12 is a front elevation view of the drill shown in FIG. 10.

FIG. 13 is a front elevation view of the drill and chuck release tool shown in FIG. 11.

### DETAILED DESCRIPTION

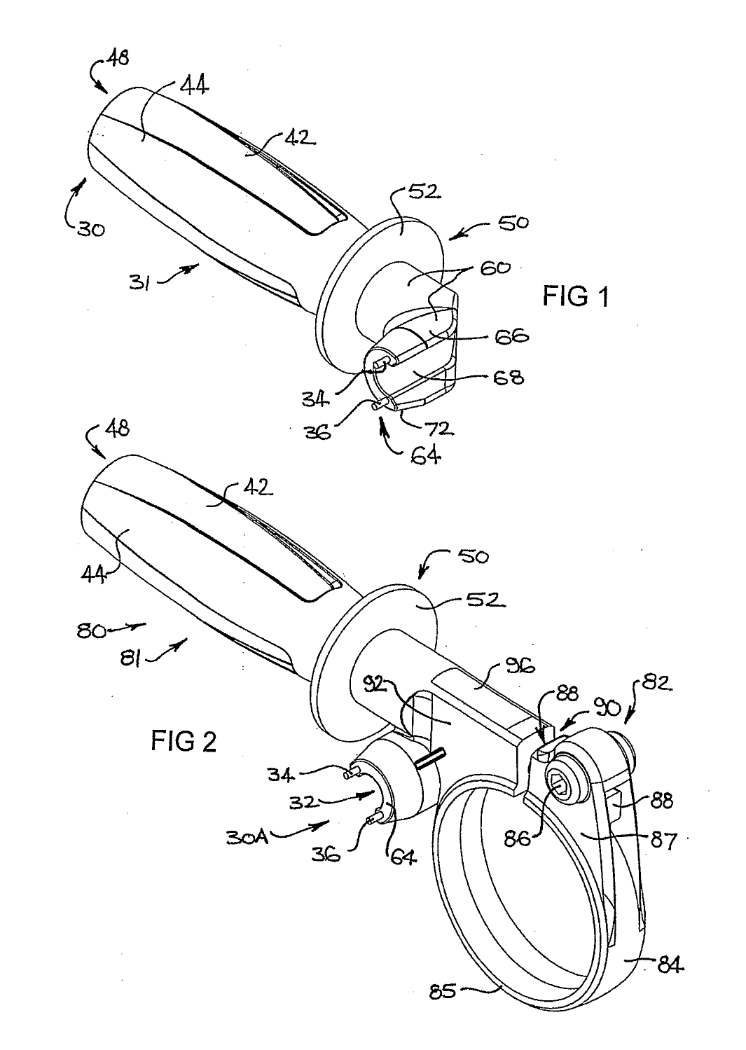

Referring to FIG. 1, there is illustrated a hand held chuck release tool 30 incorporating one embodiment of the present invention. The chuck release tool 30 includes two main sections, being a cylindrical handle 31 designed to be gripped in a user's hand; and an operational head 32 including two laterally extending cylindrical prongs 34 and 36 configured to be inserted into correspondingly shaped cavities or recesses 37, 39 on an outer face 118 of a chuck body 38 of a chuck 40 of an hand held battery powered drill 41, as shown in FIGS. 5 to 8.

The handle 31 shown in FIG. 1 consists of a generally cylindrical tube 42 having a longitudinal length substantially the same dimensions as the width of an average persons' hand. The tube 42 is coated or moulded with a hand-grip pattern comprising three circumferentially spaced apart longitudinally extending generally rectangular recessed portions 44. The recessed portions 44 extend from a distal end 46 of the handle 31 and along approximately ⅘ the longitudinal length of the handle 31. The longitudinal profile of the handle 31 is also curved, with the profile forming a convex curve over the length of the handle 31. This curved profile provides the handle 31 with a maximum cross-sectional diameter half way along the longitudinal length of the handle 31.

The free end or distal end 46 of the handle 31 is capped with a disk shaped end cap 48 which is fastened or otherwise secured within a tubular cavity 49 within the tubular handle 31. The proximate end 50 of the handle 31 includes a laterally extending circular circumferential flange 52 which effectively separates the handle 31 from the operational head 32 of the hand held tool 30. The flange 52 has a disk-like configuration having an outer diameter of approximately ⅓ larger than the average outer diameter of the tube 42 of the handle 31. The flange 52 acts as a stop or barrier, helping restrain and position a persons hand on and around the handle 31 of the tool 30.

The operational head 32 illustrated in FIG. 1 consists of an angled member including a cylindrical base portion 60 connected to the flange 52 at the proximate end of the handle 31 and a laterally extending insertion section 72 having at its free end 64 two laterally extending cylindrical prongs 34 and 36 configured for insertion into correspondingly shaped cavities or recesses 37, 39 located in an outer face 118 of the chuck body 38 of the power drill 41 chuck 40.

The insertion section 72 consists of a generally arched or half tube shaped member laterally attached to the cylindrical base portion 60 with the apex of the half tube connected to the base portion 60 of the operational head 32. The connection forms an angular intersection section 66 in which the rear side of the operational head 32 moves from a longitudinally extending direction along a 45 degree angular section 66 to a laterally extending insertion section 72.

The arched configuration of the insertion section 72 provides an arched shaped recess 68 in the upper face of the tool 30. As can be observed in FIGS. 5 to 8, this recess is designed to receive or accommodate a tool inserted into the chuck of the drill 41, in the illustrated embodiments being a drill bit 70.

Referring to FIGS. 5 to 8, the chuck 40 of the illustrated drill 41 is housed in a recessed portion accessible through a tubular cavity 43 at the front face 45 of the drill 41. The arch or truncated tubular shape of the insertion section 72 is also designed to fit into the tubular cavity 43 at the front face 45 of the drill 41. The thickness of the insertion section 72 is therefore thin to allow the section to fit within the tubular cavity 43.

Two laterally extending cylindrical prongs 34 and 36 laterally extend from the free end 64 of the insertion section 72. The cylindrical prongs 34 and 36 are spaced apart about around the perimeter of the arch, each being positioned proximate to the legs of the arch shape of, the insertion section 72. As will be further described, the insertion section 72 is used to locate the prongs 34 and 36 in corresponding cavities or recesses 37 and 39 located in the chuck 40 of the drill 41.

FIG. 2 illustrates an alternative embodiment of chuck release tool 30A of the present invention incorporated within a side handle attachment accessory 80 for a drill, such as for example the battery powered drill 41 as illustrated in FIGS. 5 to 8. These types of handles 80 are commonly used as a releasably attachable handle which can be secured to the drill 41 for use to steady the drill 41 or apply more force to a work surface when operating the drill 41.

The side handle 80 consists of a hand grip section 81 having substantially the same configuration as described for the handle 31 of the embodiment shown in FIG. 1. In this respect, the hand grip section 81 includes a moulded a hand-grip pattern comprising three equally spaced apart generally rectangular recessed portions 44, disk shaped end-cap 48 and a disk shaped flange 52 at the proximate end 50 thereof. The operational head 82 of the attachable handle 80 however includes a ring grip attachment section 84, which is designed to fit around and be secured to a cylindrical portion at the front end of a drill, such as for example the drill 41 illustrated in FIGS. 5 to 8. The ring grip attachment section 84 includes a circumferentially adjustable ring 85 having a diameter which can be enlarged or reduced by operation of adjustment nut 86. As would be appreciated by a person skilled in the art, rotation of the adjustment nut 86 operates an attached sprocket or cog (not illustrated) housed within the upper body 87 of the ring 85 which actuates extension rod 88 located in a broken section 90 of the attachment section 84. The rotation of the adjustment nut 86 either extends or retracts the extension rod 88 depending on the direction of rotation.

The chuck release tool 30A in this embodiment comprises an insertion section 32 attached to an inner side 92 of the attachment device within a right angled corner of the chuck release tool 30A. It should however be appreciated that the insertion section 32 could be located at any suitable position on the side handle 80, such as for example on the distal end of the handle 82, upper surface 96 of the attachment section or the like. The insertion section 32 is of a very similar configuration to the insertion section described for the embodiment of the invention shown in FIG. 1, having an arched or half tube shape with two laterally extending cylindrical prongs 34 and 36 extending from the free end 64 thereof.

A side handle 80 is arguably an important accessory for a drill, which is typically kept attached to the drill during operation of the drill 41. Accordingly, the inclusion of the insertion section 32 in a side handle results in a useful and convenient combination which a user will not readily lose or misplace. Furthermore, it is likely that the individual tool 30 shown in FIG. 1 will be stored separately from the drill, in for example an accessories case or tool box. In the case of the embodiment shown in FIG. 2, side handle 80 is likely to be attached to the drill 41 in most instances and therefore will allow the chuck release tool 30A to be readily available for use if and when needed.

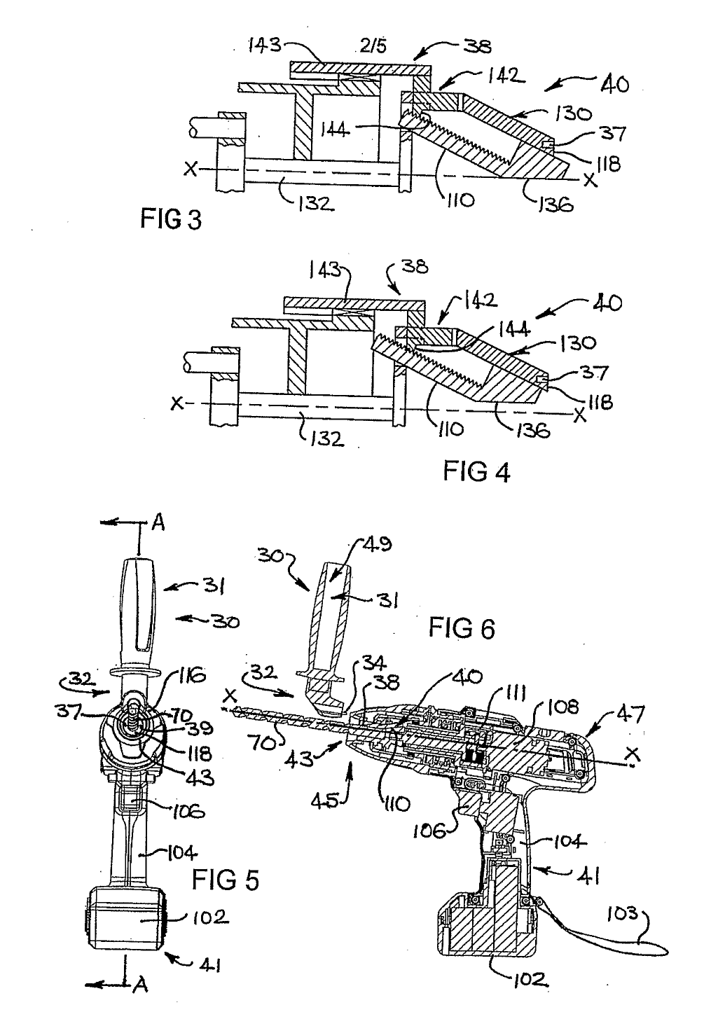

A construction of the chuck 40 and associated drill 41 with which the chuck release tool 30 or 30A can engage is shown in FIGS. 3, 4 and 6. In this arrangement, the chuck 40 includes a head portion 130 that is connected to a drive shaft 132 and to a motor 108 via a gear box 111. The head portion 130 carries three jaws 110, only one of which is illustrated in FIGS. 3 and 4. Each jaw 110 has a gripping face 136 adapted to clamp against the shank of a drill bit 70 (FIGS. 5 and 6), and adjustment means is provided to enable the jaws 110 to be moved as required according to the diameter of the drill bit 70 to be engaged.

In the particular arrangement shown, each jaw 136 is slidably mounted on the head portion 130 so as to be moveable relative to the head portion 130 along a path arranged angularly relative to the axis X-X. The adjustment means includes an adjusting nut 142 rotatably mounted to the head portion 130 and meshing with each jaw 110 through a thread 144 or worm connection. The arrangement is such that rotation of the nut 142 relative to the head portion 130 moves the gripping face 136 of each jaw 110 either towards or away from the axis X-X, as shown by FIGS. 3 and 4.

FIG. 3 shows the chuck 40 in a closed position with the jaws 110 engaged with the shank of a drill bit 70 as shown in FIGS. 5 and 6. FIG. 4 shows the chuck 40 in an open position with the jaws 110 disengaged with the shank of a drill bit 70 as shown in FIG. 8. Movement between these positions can be controlled by rotation from an electric motor 108 of the drill 41 transmitted via the shaft 132 to the head portion 130 which thereby rotates relative to the nut 142, or if the motor is disabled, by engaging the prongs 34 and 36 of the tool 30 or 30A of the present invention in the cavities or recesses 37 and 39 located in the front face of the head portion 130 of the chuck body 38 and rotating the head portion 130 relative to the nut 142.

The drill 41 is of a type that is operable to move the chuck 40 between the open and closed positions by operation of electric motor 108 of the drill 41 and without any requirement to manually hold or rotate the head portion 130. The drill 41 enables this because the chuck body 38 includes a sleeve 143 that is fixed to the nut 142 and that can be releasably locked in position relative to the drill body 47. When the sleeve 143 is locked relative to the drill body 47 this provides an adjustment mode for the drill 41 whereas when the sleeve is released from the locked position relative to the drill body 47 this provides a working mode for the drill 41. In the adjustment mode of the drill 41 the locked sleeve 143 in turn locks the nut 142 such that the motor 108 is then operable to adjust the position of the chuck jaws 136 relative to the head portion 130 and the position of the gripping face 136 of each jaw 110 towards or away from the axis X-X to grip or release the shank of the drill bit 70. In the working mode of the drill 41 the unlocked sleeve 143 in turn unlocks the nut 142 such that the motor 108 is operable to drive rotation of the chuck 40 in a manner such that the chuck 40 together with the drill bit 70 can be driven (rotated about longitudinal axis X-X) to perform a drilling/machining operation.

Accordingly, the arrangement of the drill 41 and the chuck 40 is such that the drill 41 is switchable between the adjustment mode and the working mode by respectively locking and releasing the sleeve 143 relative to the drill body 47.

FIGS. 5 to 8 show a series of views in which the chuck release tool 30 shown in FIG. 1 is used to release a drill bit 70 secured within the jaws 110 of a chuck 40 within the front portion 100 of a drill.

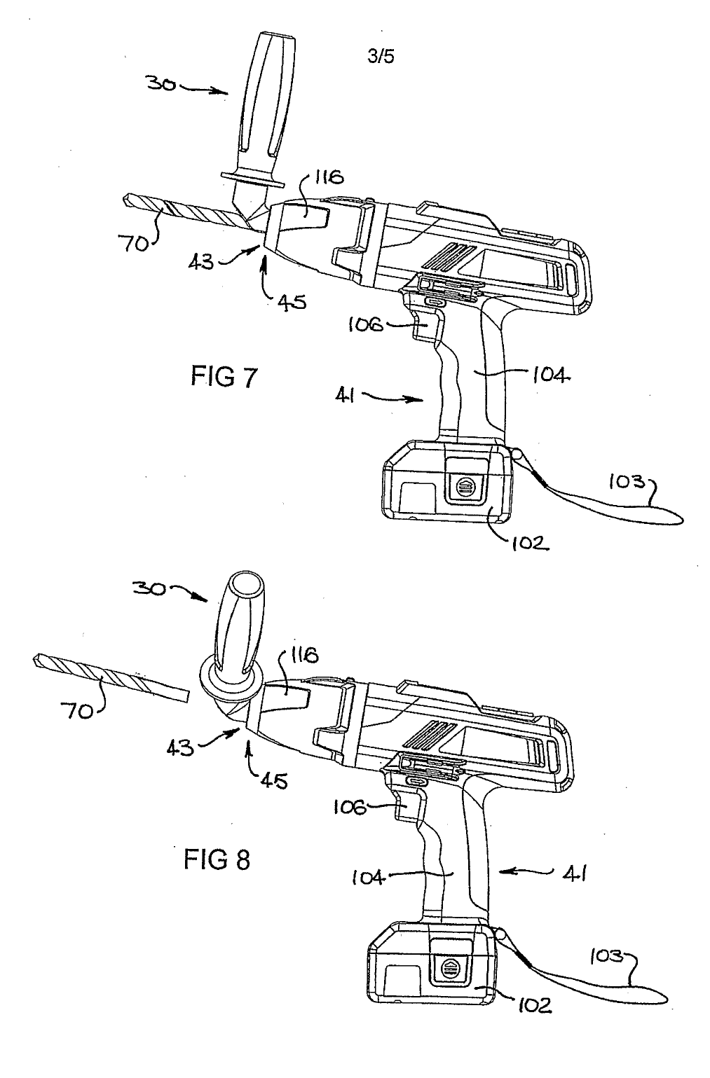

As can be readily observed in FIGS. 6 and 7, the drill 41 is similar to a typical battery operated hand held type having a removable rechargeable battery 102, arm strap 103, pistol grip section 104, finger operated trigger switch 106 which operates the rotation of electric motor 108. The electric motor 108 is connected to the chuck 40 through the gear box 111. The chuck 40 comprises a cylindrical chuck body 38 which is rotatable about an axis X-X running through the centre of the drill body 47. As shown in FIGS. 3 and 4, the chuck body 38 includes a head portion 130 in which the cavities 37 and 39 are located. Rotation of the head portion 130 relative to the nut 142 extends or retracts locking jaws 110 within the cavity 112 of the chuck 40.

As mentioned above, in normal operation, the chuck body 38 and head portion 130 is rotated by the electric motor 108 when the drill 41 is in either of the adjustment or working modes. Accordingly, when a drill bit 70 such as the one shown in FIG. 7 is inserted into the chuck cavity 112, when the drill 41 is in the adjustment mode the electric motor 108 can be actuated using trigger switch 106 and used to rotate the chuck body 38 and extend the locking jaws 110 into engagement with the portion of the drill bit 70 inserted into the chuck cavity 112 as shown in FIG. 3. The locking jaws 110 move along the thread 144 through rotation of the head portion 130 through rotation of shaft 123 actuated by the motor 108 until the drill bit 70 is tightly held within the jaws 110 of the chuck 40. Similarly, the electric motor 108 can be actuated using trigger switch 106, and used to rotate the head portion 130 of the chuck body 38 in the opposite direction to retract the locking jaws 110 from engagement with the portion of the drill bit 70 inserted into the chuck cavity 112. The locking jaws 110 are actuated by the motor 108 until the drill bit 70 is released from within the chuck 40.

In the illustrated drill 41, the head portion 130 of the chuck body 38 can also be actuated manually. This is achieved by firstly switching the drill 41 into the adjustment mode in which the sleeve 143 is locked relative to the drill body 47 and, optionally also the electric motor 108 and gear box 111 are disengaged from the power supply and the drill 41 is made safe for manual chuck operation. The chuck release tool 30 or 80 is then used to manually move the head portion 130 of the chuck body 32. This is particularly useful for removing the drill bit 70 from the drill 41 if it loses power, say, because the battery 102 goes flat.

The chuck 40 of the illustrated drill 41 is housed within an enclosed body or fascia 116 which is, as best seen in FIG. 5, accessible through a tubular cavity 43 in the front face 45 of the fascia 116. This is possible because the drill 41 is of a type that does not require a user to manually hold or rotate the chuck body 32, or any part thereof, by hand to remove the drill bit 70 but rather has the adjustment and working modes described above. The outer face 118 of the head portion 130 is readily accessible through the cavity 43, though is recessed some distance within the cavity 43. As best seen in FIG. 5, two circular cavities or recesses 37 and 39 are positioned in the outer face 118 of the head portion 130 of the chuck body 38. The cavities or recesses 37 and 39 are configured to receive the cylindrical prongs 34 and 36 of the chuck release tool 30 or 80 shown in FIG. 1 or 2.

When the drill 41 is in the adjustment mode the head portion 130 of the chuck body 38 is rotated using the chuck release tool 30 or 80 when it is required to insert or remove the drill bit 70 and the power supply to the electric motor 108 of a drill 41, such as is shown in FIG. 6, is somehow disrupted, say for example if the battery 102 goes flat. The operation of one such device will now be described:

The drill 41 is first put into adjustment mode which, as described above, specifically allows manual adjustment of the position of the chuck jaws 136 relative to the head portion 130.

As shown in FIGS. 5 and 6, the chuck release tool 30 is first orientated with the prongs 34 and 36 and insertion section 32 orientated towards the front face 45 of the drill, with the free end 64 of the insertion section 32 facing the chuck cavity 43 of the drill 41.

The chuck release tool 30 is then brought into contact with the exposed shank of the drill bit 70 and positioned directly in front of the chuck cavity 43 of the drill 41 and the insertion section 32 of the chuck release tool 30 is inserted into the chuck cavity 43 of the drill 41 with the prongs 34 and 36 inserted into corresponding cavities 37 and 39 of the head portion 130 of the chuck body 38 (FIG. 7).

The chuck release tool 30 is then rotated, in this case clockwise, moving the head portion 130 relative to the nut 142 and the sleeve 143. The locking jaws 110 are in turn moved along the thread 144 inside the head portion 130 to an open position, as shown in FIG. 4 thereby disengaging the locking jaws 110 from the portion of the drill bit 70 inserted within the chuck cavity 112, allowing a user to extract the drill bit 70 from the chuck 40 (FIG. 8).

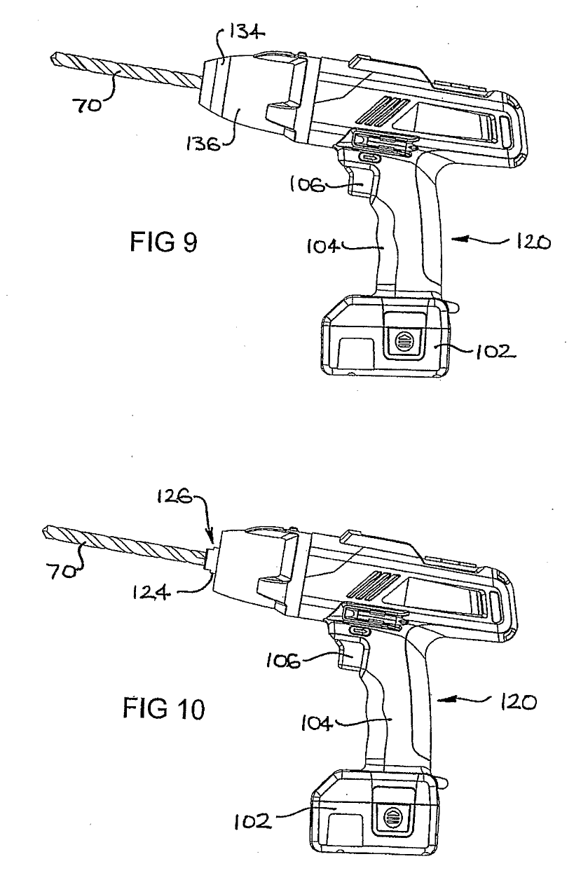

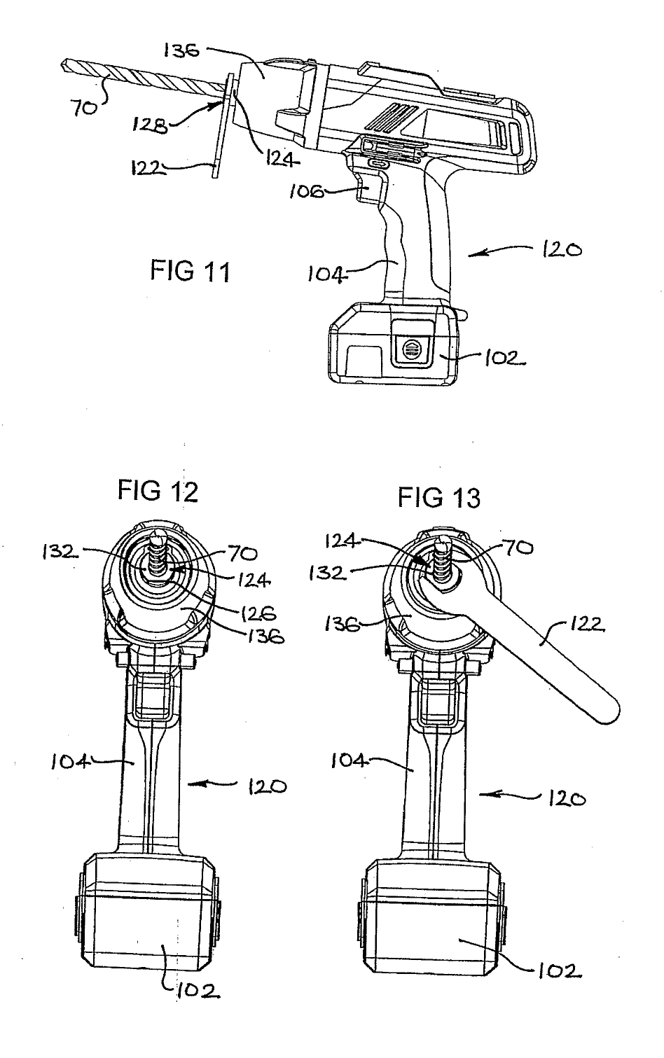

FIGS. 9 to 13 show an alternative embodiment of a drill 120 and chuck release tool 122. Again, the drill 120 is similar to a typical battery operated hand held type having a removable rechargeable battery 102, pistol grip section 104, finger operated trigger switch 106 which operates the rotation of an electric motor (not illustrated). The chuck 126 operates in a similar manner as described for the previous embodiment, including a rotatable chuck body 124.

The operational head 128 and corresponding cooperating structure on the chuck body 124 are of a different configuration to the previously described embodiment. In this embodiment, the operational head 128 of the chuck release tool 122 consists of a spanner head, having two spaced apart tines defining a generally square space therebetween. The spanner head 122 engages a correspondingly shaped chuck nut 132 located on the front face of the chuck body 124. The spanner head 122 is therefore engaged around the chuck nut 132 and rotated to operate the chuck in a similar manner as previously described.

The dimensions of the operational head 128 are such that they cannot be inserted into the opening of the front fascia 134 in a similar manner as the embodiment of the chuck release device shown in FIG. 1. In order to provide access to the chuck body 124, the front fascia 134 is provided as a releasably securable cover attached to the front portion 136 of the drill 120. As shown in FIGS. 9 and 10, the front fascia 134 comprises a hollow frustoconical section which is attachable to the front section 136 of the body of the drill 120. The attachment of this cover 134 to the front section 136 can be via fastener devices, a friction fitting rim and bead connection, rib and slot connectors or the like. When it is desired to use the chuck release tool 122, the front fascia cover 134 is removed, revealing the chuck body 124 underneath.

Those skilled in the art will appreciate that the invention described herein is susceptible to variations and modifications other than those specifically described. It is understood that the invention includes all such variations and modifications which fall within the spirit and scope.

For example, one alternate embodiment of the invention includes a similar drill configuration as shown in FIGS. 9 to 13. However, in this embodiment the operational head of the chuck release tool comprises a socket adaptor configured to releasably engage the nut 132 of the chuck body 124. Such a socket adaptor could be inserted into the opening of the front fascia 134 in a similar manner as the embodiment of the chuck release device shown in FIG. 1.

Throughout the description and claims of the specification the word “comprise” and variation of the word, such as “comprising” and “comprises”, is not intended to exclude other additives, components, integers or steps.

Future patent applications may be filed in Australia or overseas on the basis of or claiming priority from the present application. It is to be understood that the following provisional claims are provided by way of example only, and are not intended to limit the scope of what may be claimed in any such future application. Features may be added to or omitted from the provisional claims at a later date so as to further define or re-define the invention or inventions.

1.-31. (canceled)

32. A chuck release tool for a power tool,
the power tool including a chuck having a chuck body which is moved by operation of a motor of the power tool and a locking mechanism in direct connection with the chuck body for locking an operational tool within the chuck, the power tool having an adjustment mode in which operation of the motor moves the chuck body to cause the locking mechanism to move between an open position in which the operational tool is free within the chuck and a locking position in which the locking mechanism secures the operational tool within the chuck, and the power tool having a working mode in which operation of the motor moves the chuck body to drive movement of the operational tool to perform work,
the chuck release tool having an engagement section which directly engages the chuck body to allow a user to manually move the chuck body and thereby move the locking mechanism between the locking position and the open position.

33. The chuck release tool of claim 32, wherein the engagement section of the chuck release tool and the chuck body respectively include at least one rib or slot, the rib interconnecting with the slot when the engagement section is brought into engagement with the chuck body.

34. The chuck release tool of claim 32, wherein the engagement section of the chuck release tool includes two or more projections and the chuck body includes corresponding recesses in which the projections can be inserted.

35. The chuck release tool of claim 32, wherein the engagement section of the chuck release tool includes a shaped recess, slot or hole which is engageable with a correspondingly shaped surface or body included in or on the chuck body.

36. The chuck release tool of claim 35, wherein the engagement section of the chuck release tool includes a spanner type head which engages a nut shaped portion of the chuck body.

37. The chuck release tool of claim 32, wherein the engagement section of the chuck release tool includes an aperture or recessed portion for accommodating or otherwise receiving a portion of the operational tool.

38. The chuck release tool of claim 37, wherein the aperture or recessed portion includes a recess shaped to axially receive a generally cylindrically shaped operational tool.

39. The chuck release tool of claim 32, wherein the chuck body is rotated to move the locking mechanism between the open position and the locking position.

40. The chuck release tool of claim 32, wherein the locking mechanism includes one or more jaws which are moved into engagement with the operational tool in the locking position.

41. The chuck release tool of claim 32, wherein the chuck release tool includes a handle.

42. The chuck release tool of claim 41, wherein the handle includes a cylindrical hand engagement section.

43. The chuck release tool of claim 41, wherein the engagement section includes a rectangular section attached to an end of the hand section, the rectangular section including two or more laterally projecting ribs which have a generally perpendicular orientation to an axis along the longitudinal length of the handle.

44. The chuck release tool of claim 32, wherein the chuck release tool includes an attachment device which allows the chuck release tool to be releasably secured to the power tool.

45. The chuck release tool of claim 44, wherein the attachment device includes a circumferentially adjustable ring.

46. The chuck release tool of claim 44, wherein the attachment device includes a handle.

47. The chuck release tool of claim 44, wherein the attachment device includes an auxiliary or side handle which can be fitted to a front section of the power tool.

48. The chuck release tool of claim 32, wherein the engagement section of the chuck release tool extends from an elongated section of the chuck release tool which can be inserted within a recessed section of the power tool to access a chuck body housed in the recessed section enabling the engagement section to engage the chuck body.

49. The chuck release tool of claim 32, wherein the power tool includes a releasably securable front fascia which can be removed to expose the chuck body and thereby allow the engagement section of the chuck release tool to engage the chuck body.

50. The chuck release tool of claim 32, wherein the power tool is switchable between the adjustment mode and the working mode.

51. A power tool including a chuck having a chuck body which is moved by operation of a motor of the power tool and a locking mechanism in direct connection with the chuck body for locking an operational tool within the chuck, the power tool having an adjustment mode in which operation of the motor moves the chuck body to cause the locking mechanism to move between an open position in which the operational tool is free within the chuck and a locking position in which the locking mechanism secures the operational tool within the chuck, and the power tool having a working mode in which operation of the motor moves the chuck body to drive rotation of the operational tool to perform work, the chuck body including an engagement portion for direct engagement with a chuck release tool to allow a user to manually move the chuck body and thereby move the locking mechanism between the locking position and the open position.

52. The power tool of claim 51, wherein the power tool is switchable between the adjustment mode and the working mode.

53. The power tool of claim 51, wherein the chuck body includes at least one rib or slot for interconnecting with a rib or slot of the chuck release tool.

54. The power tool of claim 51, wherein the engagement portion includes recesses in the chuck body into which projections of the chuck release tool can be inserted.

55. The power tool of claim 54, wherein the recesses are in a front surface of the chuck body.

56. The power tool of claim 51, wherein the engagement portion includes a shaped recess, slot or hole which is directly engageable with a correspondingly shaped surface or body included in or on the chuck release tool.

57. The power tool of claim 51, wherein the chuck body includes a nut shaped portion for direct engagement with a spanner type head of the chuck release tool.

58. The power tool of claim 51, wherein the chuck body is housed in a recessed section of the power tool into which can be inserted the chuck release tool for direct engagement of the chuck body and the chuck release tool.

59. The power tool of claim 51, wherein the power tool is a drill.
